(19) United States
(12) Patent Application Publication
(10) Pub. No.: US 2025/0118797 A1
(43) Pub. Date: Apr. 10, 2025

(54) SOLID-STATE BATTERY MANUFACTURING USING MOLTEN SOLID-STATE ELECTROLYTE

(71) Applicant: GM GLOBAL TECHNOLOGY OPERATIONS LLC, Detroit, MI (US)

(72) Inventors: Mengyuan CHEN, Madison Heights, MI (US); Yubin ZHANG, Madison Heights, MI (US); Shaomao XU, Sterling Heights, MI (US); Xiaosong HUANG, Novi, MI (US)

(21) Appl. No.: 18/482,985

(22) Filed: Oct. 9, 2023

(51) Int. Cl. H01M 10/0562; H01M 4/04; H01M 10/052

(52) U.S. Cl. CPC H01M 10/0562; H01M 4/0404; H01M 10/052; H01M 2300/0065

(57) ABSTRACT

A method for manufacturing a composite solid-state electrolyte (SSE)/electrode for a battery cell includes providing an electrode including an active material layer. The method includes one of: melting a solid-state electrolyte to create molten solid-state electrolyte and coating the active material layer using the molten solid-state electrolyte, and arranging a solid-state electrolyte on the active material layer and heating the electrode and the solid-state electrolyte to create a molten solid-state electrolyte. The method includes solidifying the molten solid-state electrolyte to form a solid-state electrolyte layer.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to manufacturing of battery cells, and more particularly to manufacturing of composite solid-state electrolyte/electrodes using molten solid-state electrolyte.

Electric vehicles (EVs) such as battery electric vehicles (BEVs), hybrid vehicles, and/or fuel cell vehicles include one or more electric machines and a battery system including one or more battery cells, modules and/or packs. A battery control module is used to control charging and/or discharging of the battery system during charging and/or driving. Manufacturers of EVs are pursuing increased power density to increase the range of the EVs.

### SUMMARY

A method for manufacturing a composite solid-state electrolyte (SSE)/electrode for a battery cell includes providing an electrode including an active material layer. The method includes one of: melting a solid-state electrolyte to create molten solid-state electrolyte and coating the active material layer using the molten solid-state electrolyte, and arranging a solid-state electrolyte on the active material layer and heating the electrode and the solid-state electrolyte to create a molten solid-state electrolyte. The method includes solidifying the molten solid-state electrolyte to form a solid-state electrolyte layer.

In other features, the active material layer is arranged on a current collector. The molten solid-state electrolyte infiltrates an open areas between particles of the active material layer. The solid-state electrolyte has a melting temperature less than or equal to 300° C. The solid-state electrolyte is selected from a group consisting of polymer, anti-perovskite, a lithium metal halide, a lithium hydride, a lithium closo-borate, and/or combinations thereof.

In other features, the melting includes one or more processes selected from a group consisting of induction heating, a warm isostatic press (WIP), infrared light, ultrafast high-temperature sintering (UHS), flash heating, microwave heating, and spark plasma. The molten solid-state electrolyte is applied onto the active material layer using a process selected from a group consisting of injection, ultrasonic, hot rolling/pressing, and/or spraying. The active material layer further comprises active material, a binder, and a conductive filler.

In other features, the electrode comprises an anode electrode, an active material in the active material layer comprises anode active material, and the current collector comprises an anode current collector.

In other features, the electrode comprises a cathode electrode, an active material in the active material layer comprises cathode active material, and the current collector comprises a cathode current collector.

A method for manufacturing a composite solid-state electrolyte (SSE)/electrode for a battery cell includes providing an electrode including an active material layer and a wetting layer arranged on the active material layer. The method includes one of: melting a solid-state electrolyte to create molten solid-state electrolyte and coating the wetting layer using the molten solid-state electrolyte, and arranging a solid-state electrolyte on the wetting layer and heating the electrode, the wetting layer, and the solid-state electrolyte to create a molten solid-state electrolyte. The method includes solidifying the molten solid-state electrolyte to form a solid-state electrolyte layer.

In other features, the active material layer is arranged on a current collector. The wetting layer includes aluminum oxide. The solid-state electrolyte has a melting temperature less than or equal to 300° C. The solid-state electrolyte is selected from a group consisting of polymer, anti-perovskite, a lithium metal halide, a lithium hydride, a lithium closo-borate, and/or combinations thereof.

In other features, the melting includes one or more processes selected from a group consisting of induction heating, a warm isostatic press (WIP), infrared light, ultrafast high-temperature sintering (UHS), flash heating, microwave heating, and spark plasma. The molten solid-state electrolyte is applied onto the active material layer using a process selected from a group consisting of injection, ultrasonic, hot rolling/pressing, and/or spraying. The active material layer further comprises active material, a binder, and a conductive filler.

In other features, the electrode comprises an anode electrode, an active material in the active material layer comprises anode active material, and the current collector comprises an anode current collector.

In other features, the electrode comprises a cathode electrode, an active material in the active material layer comprises cathode active material, and the current collector comprises a cathode current collector.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a solid-state battery cell including electrodes manufactured using molten solid-state electrolyte according to the present disclosure;

FIG. 2 is a side cross sectional view of a battery pack including the solid-state battery cells according to the present disclosure;

FIGS. 3A to 3C are perspective views of an example of a method for melting a powdered solid-state electrolyte (SSE) onto an active material layer of an electrode according to the present disclosure;

FIG. 4 is a perspective view of an example of a method for spraying a molten solid-state electrolyte (SSE) onto an active material layer of an electrode to form a composite SSE/electrode according to the present disclosure;

FIGS. 5A and 5B are examples of electrodes before the molten solid-state electrolyte is applied according to the present disclosure; and

FIG. 6 is a flowchart of an example of a method for manufacturing composite SSE/electrodes using molten solid-state electrolyte according to the present disclosure.

In the drawings, reference numbers may be reused to identify similar and/or identical elements.

### DETAILED DESCRIPTION

While solid-state battery cells according to the present disclosure are described herein in the context of electric vehicles, the solid-state battery cells can be used in stationary applications and/or in other types of battery applications.

As compared to liquid electrolyte battery systems, solid-state batteries (SSBs) offer higher energy density and improved safety performance. However, the manufacturing process for the SSBs is complex and costly due to high-temperature and high-pressure procedures including fabrication of a sintered ceramic solid-state electrolyte membrane, a cathode/SSE composite electrode, and an anode/SSE composite electrode and stacking and sintering layers between current collectors. As can be appreciated, this manufacturing approach requires significant capital investment.

The present disclosure relates to manufacturing SSBs using molten solid-state electrolyte (SSE). The molten SSE is dispensed (or melted in-situ) onto cathode electrodes and/or anode electrodes to form composite SSE/cathode electrodes and/or SSE/anode electrodes, respectively. In some examples, the molten SSE is applied to an active material layer of the electrodes using one or more processes such as injection, ultrasonic heating, hot rolling/pressing, and/or spraying. In some examples, a heating source that melts the SSE uses induction heating, warm isostatic pressing, infrared light, ultrafast high-temperature sintering, flash heating, microwave heating, and/or spark plasma heating.

In some examples, the SSE has a melting temperature that is less than or equal to 300° C. Examples of the SSE include a polymer, an anti-perovskite, a lithium metal halide, a lithium hydride, a lithium closo-borate, and/or composites thereof. In some examples, an interlayer may be arranged between the SSE and the active material layer of the electrode to improve the wettability of the molten SSE with the active material layer of the electrode. In some examples, the interlayer comprises aluminum oxide (Al₂O₃).

Liquified/molten SSEs with low melting points (less than or equal to 300° C.) are imbibed in the active material layer of the electrode and then solidified during cooling. This approach requires less capital investment than prior processes. Using this approach eliminates the need to fabricate fragile and thin SSE layers. In addition, the SSE can be formed on current Li-ion cathode or anode electrodes. Since the SSE does not need to be handled, the SSE can be manufactured with relatively thin thicknesses as compared to other methods. Further, this approach produces low interfacial resistance.

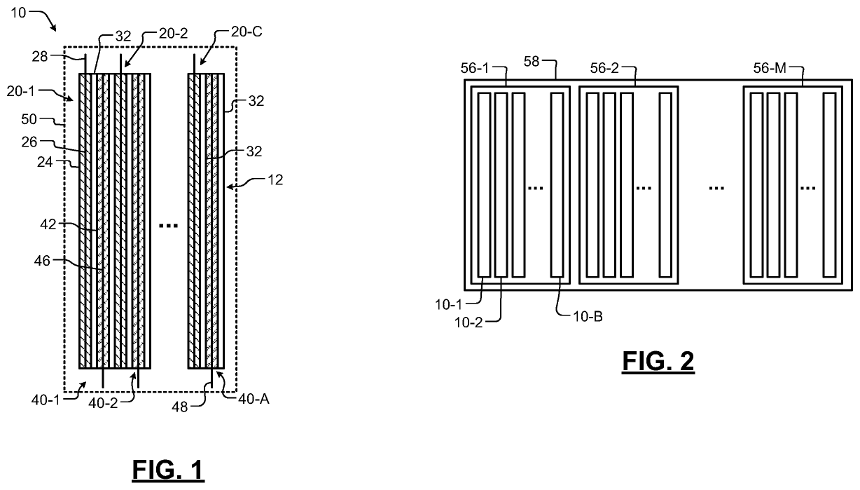

Referring now to FIGS. 1 and 2, a battery cell 10 includes cathode electrodes 20-1, 20-2, . . . , and 20-C, where C is an integer greater than one. The cathode electrodes 20 include cathode active material layers 24 arranged on one or both sides of cathode current collectors 26. The battery cell 10 includes anode electrodes 40-1, 40-2, . . . , and 40-A, where A is an integer greater than one. The anode electrodes 40 include anode active material layers 42 arranged on one or both sides of anode current collectors 46. The cathode electrodes 20, the anode electrodes 40, and S separators 32 are arranged in a predetermined order in a battery cell stack 12 that is arranged in an enclosure 50, where S is an integer greater than one. For example, separators 32 are arranged between the cathode electrodes 20 and the anode electrodes 40. External tabs 28 and 48 of the cathode electrodes 20 and the anode electrodes 40 can be arranged in the same side, different sides, and/or opposite sides. The external tabs 28 and 48 allow connection between the cathode electrodes 20 and the anode electrodes 40 and terminals of the battery cell 10.

In FIG. 2, a battery pack 58 includes M battery modules 56-1, 56-2, . . . , and 56-M each including B of the battery cells 10 (e.g., battery cells 10-1, 10-2, . . . , and 10-B), where B and M are integers greater than one.

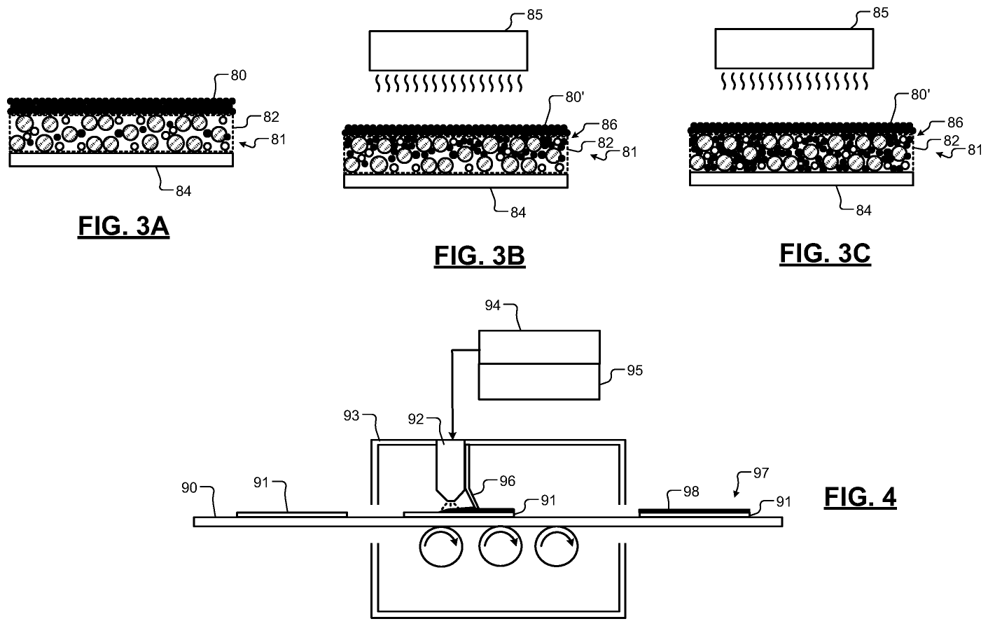

Referring now to FIGS. 3A to 3C, an example of melting of SSE powder 80 onto an electrode 81 including an active material layer 82 and a current collector 84 is shown. In FIG. 3A, the SSE powder 80 is arranged on the active material layer 82 and heated above a melting temperature of the SSE powder. In FIG. 3B, melted SSE powder 80′ starts to infiltrate open areas between particles of the active material layer 82 (as shown at 86). After heating is completed, the melted SSE powder 80′ substantially fills the open volume as shown in FIG. 3C. As will be described further below, in other examples the SSE is melted prior to contact with the electrode.

Referring now to FIG. 4, an example of a manufacturing method is shown. A conveying system 90 supplies an electrode 91 (either discrete electrodes or a continuous electrode) to an enclosure 93 including a dispenser 92 (e.g., an injector or sprayer) that dispenses molten SSE onto the electrode 91. A leveling device 96 levels a thickness of the molten SSE on the electrode 91 to form a composite SSE/electrode 97 with an SSE layer 98 (e.g., having a predetermined thickness less than 50 μm in some examples).

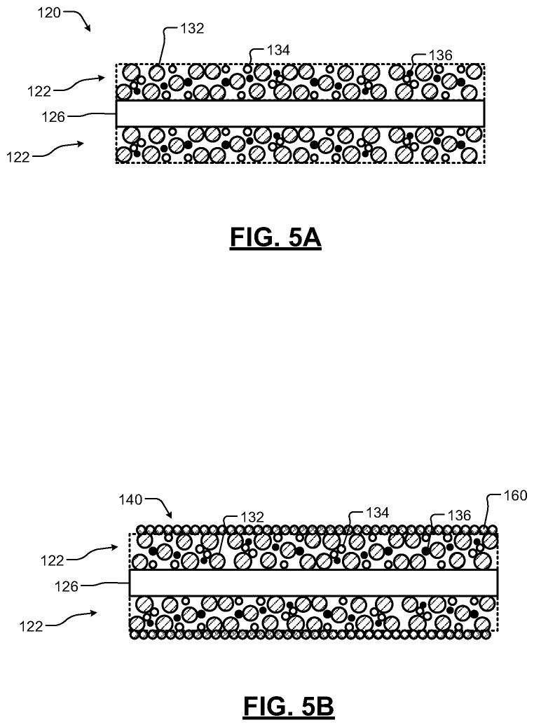

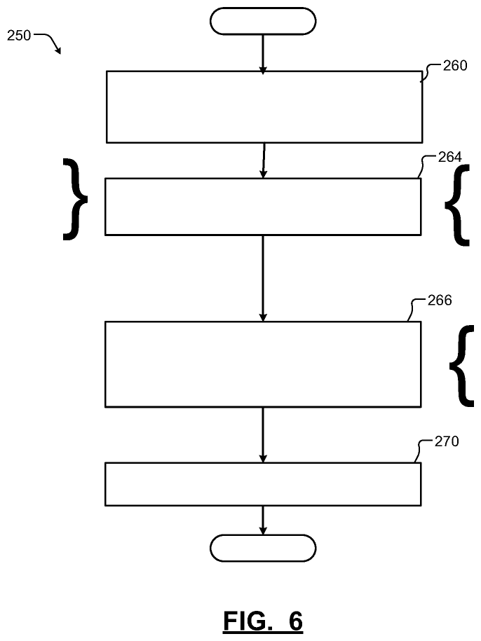

Referring now to FIGS. 5A and 5B, examples of electrodes are shown prior to the addition of the molten SSE. In FIG. 5A, an electrode 120 (e.g., a cathode electrode and/or an anode electrode) includes an active material layer 122 arranged on one or both sides of a current collector 126. The active material layer 122 includes different types of particles that include one or more of active material 132, conductive filler 134, binder 136, and/or other materials. After manufacturing the electrode 120 with the active material layer 122, a portion of molten solid-state electrolyte infiltrates open areas of the active material layer 122 and other portions form the SSE layer 98 (FIG. 4).

In FIG. 5B, an electrode 140 (e.g., a cathode electrode and/or an anode electrode) include an active material layer 142 arranged on one or both sides of a current collector 146. The active material layer 142 includes different types of particles that include one or more active materials 152, conductive filler 154, binder 156, and/or other materials. In some examples, a wetting layer 160 is applied on an outer surface of the active material layer 142. In some examples, the wetting layer 160 includes aluminum oxide (Al₂O₃). After manufacturing the electrode 140 with the active material layer 142, a portion of molten solid-state electrolyte 138 infiltrates open areas of the active material layer 122 and other portions form the SSE layer 98 (FIG. 4).

Referring now to FIG. 6, a method 250 for manufacturing electrodes and battery cells using molten solid-state electrolyte is shown. At 260, an electrode includes one or more active material layers arranged on a current collector. In some examples, the active material layers include an optional wetting layer. At 264, solid-state electrolyte is melted into molten solid-state electrolyte either in situ on the electrode or melted to a molten state prior to coating the electrode. In some examples, the solid-state electrolyte has a melting temperature less than or equal to 300° C. In some examples, the solid-state electrolyte is selected from a group consisting of polymer, anti-perovskite, a lithium metal halide, a lithium hydride, a lithium closo-borate, and/or combinations thereof. In some examples, the melting includes one or more processes selected from a group consisting of Induction heating, a warm isostatic press (WIP), infrared light, ultrafast high-temperature sintering (UHS), flash heating, microwave, and/or spark plasma.

At 266, a portion of the molten solid-state electrolyte infiltrates the one or more active material layers and other portions form the SSE layer 98 (FIG. 4). In some examples, the molten solid-state electrolyte is applied onto the one or more active material layers using a process selected from a group consisting of injection, ultrasonic, hot rolling/pressing, and/or spraying. At 270, the electrode is arranged along with other electrodes (cathode electrodes and/or anode electrodes) and separators to form a battery cell stack and arranged in an enclosure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing a composite solid-state electrolyte (SSE)/electrode for a battery cell, comprising:
providing an electrode including an active material layer;
one of:
melting a solid-state electrolyte to create molten solid-state electrolyte and coating the active material layer using the molten solid-state electrolyte, and
arranging a solid-state electrolyte on the active material layer and heating the electrode and the solid-state electrolyte to create a molten solid-state electrolyte; and
solidifying the molten solid-state electrolyte to form a solid-state electrolyte layer.

2. The method of claim 1, wherein the active material layer is arranged on a current collector.

3. The method of claim 1, wherein the molten solid-state electrolyte infiltrates an open areas between particles of the active material layer.

4. The method of claim 1, wherein the solid-state electrolyte has a melting temperature less than or equal to 300° C.

5. The method of claim 1, wherein the solid-state electrolyte is selected from a group consisting of polymer, anti-perovskite, a lithium metal halide, a lithium hydride, a lithium closo-borate, and/or combinations thereof.

6. The method of claim 1, wherein the melting includes one or more processes selected from a group consisting of induction heating, a warm isostatic press (WIP), infrared light, ultrafast high-temperature sintering (UHS), flash heating, microwave heating, and spark plasma.

7. The method of claim 1, wherein the molten solid-state electrolyte is applied onto the active material layer using a process selected from a group consisting of injection, ultrasonic, hot rolling/pressing, and/or spraying.

8. The method of claim 1, wherein the active material layer further comprises active material, a binder and a conductive filler.

9. The method of claim 2, wherein:
the electrode comprises an anode electrode,
an active material in the active material layer comprises anode active material, and
the current collector comprises an anode current collector.

10. The method of claim 2, wherein:
the electrode comprises a cathode electrode,
an active material in the active material layer comprises cathode active material, and
the current collector comprises a cathode current collector.

11. A method for manufacturing a composite solid-state electrolyte (SSE)/electrode for a battery cell, comprising:
providing an electrode including an active material layer and a wetting layer arranged on the active material layer;
one of:
melting a solid-state electrolyte to create molten solid-state electrolyte and coating the wetting layer using the molten solid-state electrolyte, and
arranging a solid-state electrolyte on the wetting layer and heating the electrode, the wetting layer, and the solid-state electrolyte to create a molten solid-state electrolyte; and
solidifying the molten solid-state electrolyte to form a solid-state electrolyte layer.

12. The method of claim 11, wherein the active material layer is arranged on a current collector.

13. The method of claim 11, wherein the wetting layer includes aluminum oxide.

14. The method of claim 11, wherein the solid-state electrolyte has a melting temperature less than or equal to 300° C.

15. The method of claim 11, wherein the solid-state electrolyte is selected from a group consisting of polymer, anti-perovskite, a lithium metal halide, a lithium hydride, a lithium closo-borate, and/or combinations thereof.

16. The method of claim 11, wherein the melting includes one or more processes selected from a group consisting of induction heating, a warm isostatic press (WIP), infrared light, ultrafast high-temperature sintering (UHS), flash heating, microwave heating, and spark plasma.

17. The method of claim 11, wherein the molten solid-state electrolyte is applied onto the active material layer using a process selected from a group consisting of injection, ultrasonic, hot rolling/pressing, and/or spraying.

18. The method of claim 11, wherein the active material layer further comprises active material, a binder and a conductive filler.

19. The method of claim 12, wherein:
the electrode comprises an anode electrode,
an active material in the active material layer comprises anode active material, and
the current collector comprises an anode current collector.

20. The method of claim 12, wherein:
the electrode comprises a cathode electrode,
an active material in the active material layer comprises cathode active material, and
the current collector comprises a cathode current collector.
